(19) United States
(12) Patent Application Publication
(10) Pub. No.: US 2006/0096960 A1
(43) Pub. Date: May 11, 2006

(54) Method of marking and tracking objects

(75) Inventors: Ronald E. Carson, Sacramento, CA (US); Michael Woogerd, Seattle, WA (US); Samantha Woogerd, Seattle, WA (US)

Correspondence Address: JENSEN + PUNTIGAM, P.S., SUITE 1020, 2033 6TH AVE, SEATTLE, WA, 98121, US

(73) Assignee: Mobile Tool Management, Inc., Seattle, WA (US)

(21) Appl. No.: 10/985,310

(22) Filed: Nov. 9, 2004

(51) Int. Cl. B23K 26/16; B23K 26/00

(52) U.S. Cl. 219/121.68; 219/121.71

(57) ABSTRACT

Method and apparatus for marking items, including a portable laser programmed to mark an object within its range of movement, where the object is supported by a base capable of supporting objects of a variety of sizes at the appropriate height for marking The marking could be for identification purposes or for cataloging and tracking.

### TECHNICAL FIELD

This invention relates to the localized marking or identifying of objects, and in particular, the providing of a portable laser unit wherein a conformable bed is placed to support objects of any shape in a position where the face to be marked is properly placed for marking.

This invention further relates to the management and control of tools or instruments, in that the individual tool or instrument is sequentially marked in the field, utilizing a portable laser marking device, in conjunction with a unique platform for supporting tools or instruments of a variety of shapes and sizes, while maintaining the surface to be marked at the appropriate distance from the laser, and then storing the information on the tool or instrument in a computer program for future reference as to maintenance, replacement or simply retrieval.

### BACKGROUND OF THE INVENTION

It is often desirable to mark personal belongings so that they are easily identified, but it is often not convenient to do so, and it would be a service to provide this option in shopping malls or the like.

Historically, in many fields of endeavor, it has been critical to accumulate, maintain and periodically replace tools or instruments in order to insure maximum efficiency in the workplace. Endeavors to which tools or instruments are important include such venues as hospitals, auto repair, maintenance shops, and/or manufacturing facilities. The task of tool inventory and maintenance has been met historically through manual inspection or physical cataloging, i.e., each tool or instrument has its assigned place and generally arbitrary replacement.

Proprietors have adapted the procedure of marking each instrument so that they can be more easily controlled. The control of these instruments includes making sure that the correct instrument or tool is being used on the particular machine; that all of the tools or instruments are returned to the proper storage location following the completion of a task; to record the current use of the instrument for purposes of maintenance and/or replacement, among others.

Historically, the marking of the instruments has required that the current inventory or new instruments be removed from the facility, marked and then returned. This process requires an initial manual inventory, packaging the instruments, transporting them to the place of marking, and then the reverse process. This operation is time consuming, costly, and removes the tools or instruments from the facility.

### SUMMARY OF THE INVENTION

With the above-noted process in mind, it is one of the purposes of the present invention to provide a means whereby the inventory of instruments and/or tools may be quickly and inexpensively marked in place, thereby eliminating a substantial period of down time.

Another purpose of the present invention is to provide a method whereby the instruments and/or tools may be marked at their location, and simultaneously have the desired information entered into a program providing a straightforward method of inventory.

Still another purpose of the present invention is to provide a comprehensive method of employing and marking a large volume of tools in the place they would normally reside, utilizing a software driven laser, which minimizes the time involvement.

A further purpose is to provide a portable marking device and method which may be used at any convenient location.

### BRIEF DESCRIPTION OF THE DRAWINGS

FIG. 1 is an isometric view of an instrument designed to support tools, instruments or other objects during marking.

FIG. 2 is a section view through the apparatus of FIG. 1.

FIG. 3 is a block diagram outlining the steps in the current inventive method.

### BEST MODE FOR CARRYING OUT THE INVENTION

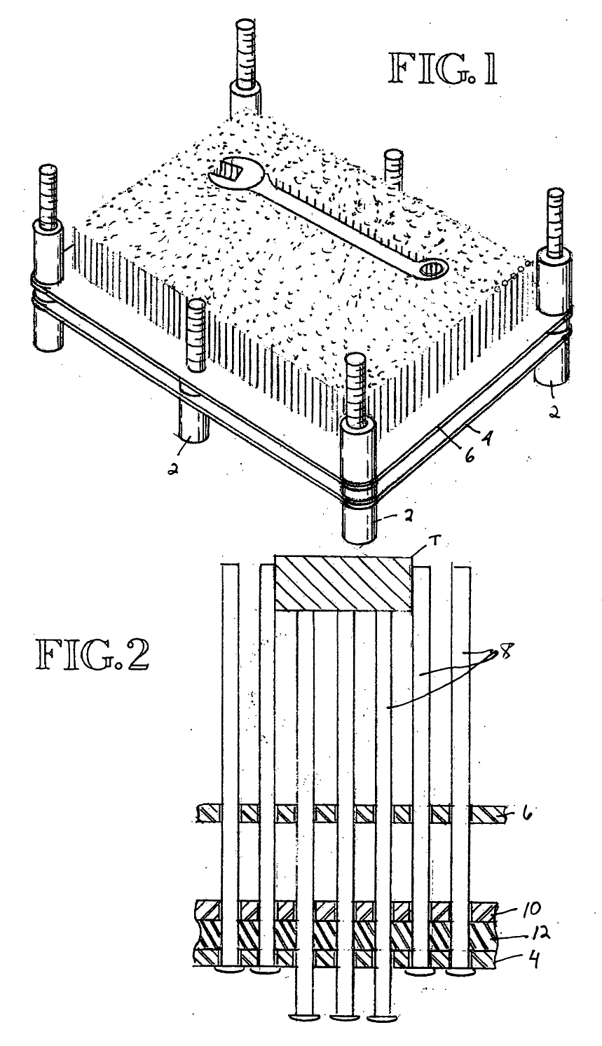

As seen in FIG. 1, there is a tool/apparatus utilized in the present invention for supporting tools or instruments to be marked. Since the portable laser is designed to do the marking at a predetermined distance from the lens, the instrument to be marked must be appropriately placed. The instrument in FIG. 1, which has a multiplicity of individual, vertically disposed, frictionally held, movement resistant pins, allows a tool, instrument or object to be appropriately placed for marking by simply displacing those pins immediately beneath the instrument to an appropriate position while supporting the surface to be marked in the necessary plane.

As will be explained hereinafter, the current inventive method requires a predetermined and constant placement of the tools or instruments to be marked, since the program used for sequentially marking the tools is preprogrammed for a particular location in the range of its movement.

Referring now to FIG. 1, the vertical legs 2 support a bed of discreet vertical pins supported by a platform including plates 4 and 6, which serve to maintain the pins in a vertical orientation, as explained hereinafter. The legs likewise insure that the platform is appropriately located within the range of the laser lens by being placed in a template, insuring that the platform is always located at the same position beneath the laser.

Reference is now had to FIG. 2, where it can be seen that the tool T, supported by a plurality of pins 8 which are held in vertical position by parallel plates 4 and 6. It is to be noted that there is also a third horizontal plate 10 such that a friction element such as a suede fabric is sandwiched between 4 and 10 to provide resistance to the vertical movement of the pins 8, allowing the pins to support the tool T, as best seen in FIG. 1. The pins may be adjusted to accommodate a large variety of objects of differing shape and dimension.

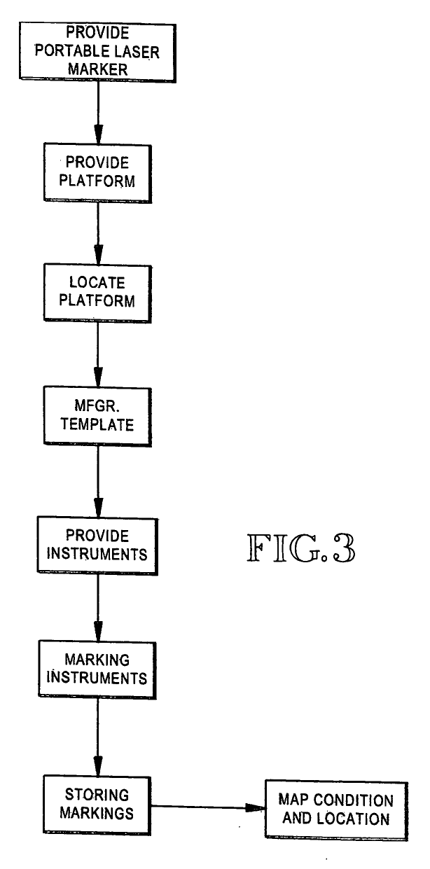

Attention is now has to FIG. 3, wherein the block diagram outlines the steps in the current inventive method. As described hereinabove, the tool or instrument is either coated with a laser marking material, such as LMM 12 from Thermark corporation (for CO₂ lasers) or not coated (for YAG lasers) before being placed in the laser. Then the laser is moved to the location of the instruments or tools and then a portable platform is provided to support the tools at the appropriate height for marking. This platform could be part of a fixture, as illustrated in FIG. 1 or 2 or in the alternative could be pre-molded support system or any other apparatus which allows quick and easy vertical placement of the tools for the laser marking. The platform is located beneath the laser in the appropriate location, wherein the location is determined by the program which drives the laser by cutting a template, assuring the location of the platform is consistent. Once the support system for the platform is located, the preferred embodiment, utilizing the device of FIGS. 1 and 2, the location of the individual tools or instruments is likewise determined by the program, which in this case could be the program “Bartender”, manufactured by Seagull Scientific or any graphics program such as “Autocad” or “CorelDRAW”. The program directs the laser to cut a template for the tools to be marked, such that not only is their vertical location predetermined by the platform, but the horizontal location is likewise predetermined by the template. The instruments are then provided, placed within the template at the appropriate height, and the instruments are sequentially marked by the program. Following the marking, the tools or instruments are returned to their appropriate location and the markings are stored within the program. Once the laser has marked a unique serial number on the tool or instrument, an adjunct tool management database program such as Cribmaster from Winware, likewise has the capability of mapping the condition of the tool or instrument and the location where it should be stored.

As noted hereinabove, the program likewise tracks the instruments in terms of when they are removed from its storage place, wherein they are to be used, when they are returned and other data necessary for complete control and inventory of the tools or instruments.

Further, as noted hereinabove, the inventive apparatus and method could easily be transported to a shopping mall or the like where it could be used for marking any object with an individual identifying mark.

Thus, as can be seen the present invention provides a simple, straightforward, and inexpensive method of actually marking and thereafter inventorying and maintaining a plurality of tools and/or instruments.

1. A method of sequentially marking tools, instruments or objects for identification, comprising:
a) providing a flexible support platform to assure that the face of the tools to be marked are located in the same horizontal plane;
b) providing a template assuring that each tool is consistently located on the platform;
c) sequentially marking each tool with a bar code, and/or unique serial number, utilizing a laser; and
d) storing the individual markings in a computer data base, whereby each tool may be tracked.

2. A method as in claim 1, wherein the support platform is comprised of a plurality of vertically disposed, selectively displaceable pins.

3. A method as in claim 1, wherein the laser is program controlled and prepares the template which prepositions the objects to be marked.

4. A method of marking a plurality of instruments, comprising:
transporting a portable laser unit to the location of the instruments;
prepping the tool or instrument with a laser marking coating;
positioning a vertical flexible platform, within the limits of the laser movement;
defining the section of the platform where each instrument is to be placed;
cutting a template to reflect the placement of the instruments;
placing the instruments to be marked; and
actuating the program and sequentially marking the instruments.

5. A method as in claim 4 and including the step of
storing predetermined material for later access.

6. A method of marking objects comprising:
providing a portable programmable laser marking device;
providing a flexible bed capable of conforming to the underside of the object to be marked, supporting the object and maintaining the object at the appropriate position relative to the laser lens for marking within the range of motion of the laser;
placing the bed beneath the laser;
placing the object on the bed; and
initializing the program to mark the object.
